(19) United States
(12) Patent Application Publication
(10) Pub. No.: US 2023/0247922 A1
(43) Pub. Date: Aug. 10, 2023

(54) THREE-POINT HITCH HOOK UP ASSIST SYSTEM

(71) Applicant: Zimeno, Inc. dba Monarch Tractor, Livermore, CA (US)

(72) Inventors: Zachary Meyer OMOHUNDRO, Livemore, CA (US); Chenjia YIN, Shanghai (CN); Avery Jutkowitz, Pleasanton, CA (US); Yogesh Madhavrao CHUKEWAD, Pleasanton, CA (US)

(73) Assignee: Zimeno, Inc. dba Monarch Tractor, Livermore, CA (US)

(21) Appl. No.: 18/164,592

(22) Filed: Feb. 5, 2023

Related U.S. Application Data
(60) Provisional application No. 63/306,758, filed on Feb. 4, 2022.

(51) Int. Cl. A01B 59/06

(52) U.S. Cl. CPC A01B 59/068

(57) ABSTRACT

A three-point hitch hookup assist system may include a three-point hitch system. The three-point hitch system may include a lower link having a first connection about which the lower link pivots and an implement connector, a powered actuator to pivot the lower link, a first sensor coupled to the lower link to output signals indicating a manual force applied by an operator to the lower link, and a controller. The controller may output control signals to the powered actuator to cause the powered actuator to apply an assist force to the lower link based upon the sensed manual force.

### CROSS-REFERENCE TO RELATED PATENT APPLICATIONS

The present application patent application claiming priority under 35 USC 119 from co-pending U.S. Provisional Patent Application Ser. No. 63/306,758 filed on Feb. 4, 2022, by Omohundro et al. and entitled THREE-POINT HITCH HOOK UP ASSIST SYSTEM, the full disclosure of which is hereby incorporated by reference.

### BACKGROUND

The agricultural tractor is normally hooked up to an implement that may carry the implement, or constitutes a vehicle train set when towing the implement.

The human operator is still essential for the hook up of the implement to the tractor. Many implements are equipped with three-point hitches. The three-point hitch hookup operation is not always straight forward, can be unsafe and time consuming, especially when the operator performs the hook up task alone.

To assist system the operator and facilitate the hookup operation some large tractors have control assist system knobs located outside the tractor cab, on the rear of the tractor and close to the implement. The operator can lower and raise the links by operating the knobs.

However, the attachment of the tractor links to the implement links through link pins still requires accurate alignment in positioning the tractor link ends close to the mating counterparts on the implement. The use of the knob is not quite intuitive and flexible. Furthermore, an assistant may inadvertently turn the knob and injure the operator.

### BRIEF DESCRIPTION OF THE DRAWINGS

FIG. 1 is a diagram schematically illustrating portions of an example three-point hitch hookup assist system.

FIG. 2 is a flow diagram of an example method that may be carried out by the example system of FIG. 1.

FIG. 3 is a flow diagram of an example method that may be carried out by the example system of FIG. 1.

FIG. 4 is a rear perspective view of an example tractor including example three-point hitch hookup assist systems.

FIG. 5 is an enlarged view of a portion of the tractor of FIG. 4.

FIG. 6 is a diagram schematically illustrating portions of one of the example three-point hitch hookup assist systems of the tractor of FIGS. 4 and 5.

FIG. 7 is a flow diagram of an example method that may be carried out by the tractor of FIGS. 4 and 5.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example three-point hitch hookup assist systems for a vehicle three-point hitch. Disclosed are example tractors that include an example three-point hitch hookup assist system. Disclosed are example methods for assisting an operator in hooking up a three-point hitch to an implement.

The example three-point hitch hookup assist systems sense the manual force applied to a lower link of a three-point hitch. The example three-point hitch hookup assist systems further apply an assist force to the lower link based upon the sensed manual force. The assist force may lessen the amount of force or the amount of work that would otherwise be required of the operator to manually raise or lower the lower link. As a result, the operator may more easily manually reposition the lower link of the three-point hitch to a desired position in alignment with connectors associated with the implement to be attached. Because the operator may manually reposition the link by directly applying manual force to the lower link, repositioning of the lower link into alignment with an implement attachment point may be more intuitive and more easily performed.

In some implementations, the vehicle, such as a tractor, may include two hookup assist systems, one for each of the lower links of a three-point hitch. For example, in some implementations, the first lower link may be associated with a first sensor that senses a manual force applied by an operator to the first lower link. A controller may utilize the sensed manual force applied by the operator to the first lower link to cause a powered actuator to apply an assist system force to the first lower link. Likewise, the second lower link may be associated with a second sensor that senses a manual force applied by an operator to the second lower link. The controller may utilize the sensed manual force applied by the operator to the second lower link to cause a powered actuator to apply an assist system force to the second lower link.

In some implementations, the example three-point hitch hookup assist systems sense the applied manual force and apply the assist system force in a closed loop manner. For example, in some implementations, the hookup assist system begins by applying an initial powered force to a lower link. The initial powered force may be a force determined based upon the weight and angular position of the lower link, wherein the force has a value to stationarily support or retain the lower link at an existing height or angular position.

During powering on of the vehicle or during those periods of time that the vehicle is in a three-point hitch assist mode (based upon input from an operator or signals from a sensor), the current upward force experienced by the lower link may be sensed. This current force is compared to the powered force that was previously applied by a powered actuator to the lower link. If the current force experienced by the lower link is different than the powered force applied by the powered actuator, a determination is made that a manual force is currently being applied to the lower link by an operator. The difference between the powered force and the current force is the manual force.

In response to determining that a manual force is being applied to the lower link, the powered force applied by a powered actuator is adjusted. The adjustment may be based the sensed manual force (which is based upon the difference between the current force and the previously applied powered force). For example, if the determined manual force is occurring in an upward direction, lifting the lower link, the powered actuator be adjusted to apply an increased upward force to assist the operator in lifting the lower link. If the determined manual force is occurring in a downward direction, lowering the lower link, the powered actuator may be adjusted to apply a smaller upward force (or a downward force) to assist in lowering the lower link.

In response to determining that a manual force is no longer being applied to the lower link (the current force is equal to the previously applied powered force), no further adjustments to the powered force are made. As a result, the lower link remains stationary at its current angular position.

In one example implementation, the system may include a powered actuator to apply an upward force to the lower link and may include a sensor to sense a current upward force experienced by the lower link. In response to sensing that the current upward force experienced by the lower link is different than the previously applied and measured powered upward force, it may be determined that manual force is being applied to lift or lower the lower link. In response to such a determination, the powered force is adjusted based upon the difference between the current force experienced by the lower link and the prior powered force (new PF=PF+(CF−PF)). If the current force CF is greater than the last sensed and measured, previously applied power force PF, the power force applied to the lower link is increased. If the current force CF is less than the last sensed and measured, previously applied power force PF to the lower link, the power force applied to the lower link is decreased.

In some implementations, the three-point hookup assist system utilizes a hydraulic piston-cylinder assembly as a powered actuator to apply the powered force to the lower link. The powered force and the current force are both determined by comparing the hydraulic pressure on opposite sides of the piston (the rod side versus the piston or cap side). For example, in implementations where hydraulic pressure on the rod side raises the lower link, the pressure P1 on the cap side and the pressure P2 on the rod side are measured. The powered force/current force is a difference between P1 and P2. The upward current force and the upward powered force are based upon the pressure P2 minus the pressure P1.

The current force measurements and the powered force measurements may be transmitted to a controller that controls operation of the powered actuator, that controls operation of the hydraulic pump and/or directional control valve associated with the piston-cylinder assembly. The controller may adjust operation of the powered actuator to provide the assist force that assists the operator in manually raising or manually lowering the lower link.

In some implementations, the three-point hitch hookup assembly is part of a tractor having a three-point hitch. In some implementations, the tractor may include an operator interface providing the operator with information and for receiving input or commands from the operator. In some implementations, the tractor may enter a three-point hitch hookup assist mode based upon commands or input from the operator using the operator interface. Entry into the three-point hitch hookup assist system mode triggers the automatic provision of assist system forces based upon any sensed manual force being applied to either of the lower links. In some implementations, the frequency at which the assist system forces are applied during attempted manual raising or lowering of a lower link may be adjusted based upon input received from the operator using the operator interface. This frequency is the frequency at which the pressures P2 and P1 are compared, and adjustments are made to the supply of hydraulic fluid to the rod side and the cap side of the hydraulic cylinder-piston assembly.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

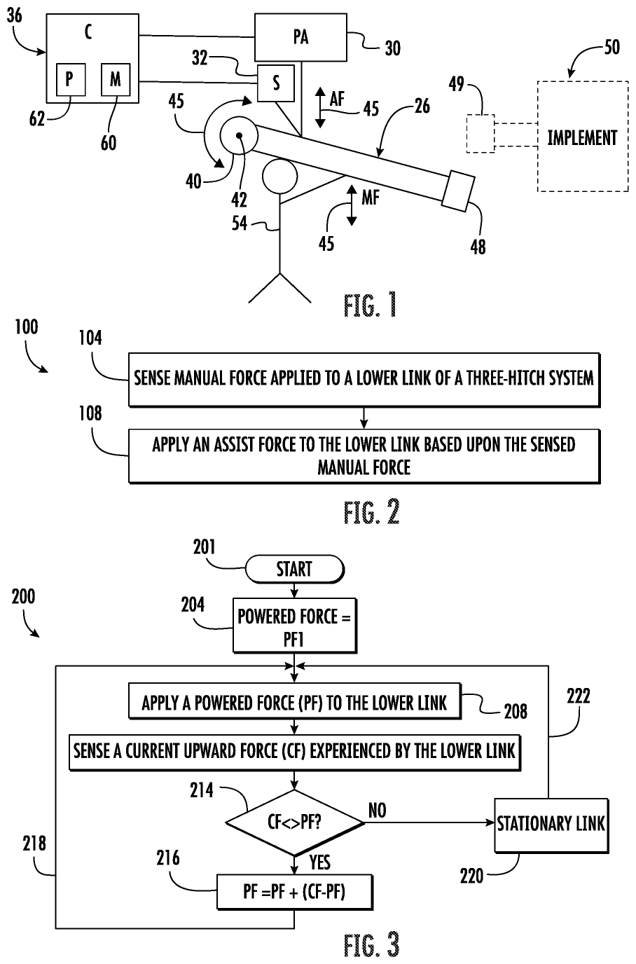

FIG. 1 is a diagram schematically illustrating portions of an example three-point hitch hookup assist system 20 for use as part of a tractor or other vehicle having a three-point hitch. Hookup assist system 20 senses the manual force applied to a lower link of a three-point hitch. The hookup assist system further applies an assist force to the lower link based upon the sensed manual force. As a result, the operator may more easily manually reposition the lower link of the three-point hitch to a desired position in alignment with connectors associated with the implement to be attached.

Because the operator may manually reposition the link by directly applying manual force to the lower link (directly gripping the lower link while applying an upward or downward force to the lower link), repositioning of the lower link into alignment with an implement attachment point may be more intuitive and more easily performed. Hookup assist system 20 comprises lower link 26, powered actuator 30, sensor 32 and controller 36.

Lower link 26 comprises one of two lower links on the three-point hitch. Lower link 26 cooperates with the other lower link and an upper link to form the three-point hitch. Lower link 26 may be in the form of an elongated rod, bar or arm. Lower link 26 comprises a first connection 40 about which the lower link pivots about axis 42 in either of the directions as indicated by arrows 45. The lower link further comprises an implement connector 48 for releasable connection to a connection point 49 of implement 50 (schematically shown in broken lines). Connection 40 facilitates pivoting of lower link 26 about axis 42 to reposition or move them connector 48 into sufficient alignment with connection point 49 for connection to implement 50.

Powered actuator 30 comprises a non-human powered mechanism configured to lower or raise lower link 26 and its connection point 48 by pivoting lower link 26 about axis 42. In some implementations, powered actuator 30 comprises a hydraulic cylinder-piston assembly. The hydraulic cylinder-piston assembly may be powered by an electrical source, such as a battery, which powers a hydraulic pump that supplies pressurized hydraulic fluid to move a piston within a cylinder or which powers an electric motor that drives the hydraulic pump. The hydraulic pump may be powered by torque provided by an internal combustion engine. In yet other implementations, the powered actuator 30 may comprise a pneumatic piston-cylinder assembly, an electric solenoid or other mechanisms for generating applying a powered force to prevent the lower link 26 from pivoting (maintaining the lower link 26 in a stationary orientation) and to selectively raise or lower the lower link 26 to a new angular position.

Sensor 32 comprises a sensing device coupled to lower link 26 or the powered actuator 30 so as to output signals indicating or from which may be derived a manual force MF applied by an operator 54 (schematically shown) to the lower link 26. As schematically shown in FIG. 1, the operator 54 may grasp the lower link 26 with his or her hands and may apply an upward or downward manual force MF with his or her hands, arms and legs in an effort to pivot lower link 26 about axis 42 to raise or lower the lower link 26. Although such force may, by itself, be insufficient to move lower link 26 or cannot be sustained to move lower link 26 by a desired distance or degree, sensor 32 may sense the manual force MF directly or indirectly.

In some implementations, sensor 32 may comprise a strain sensor operably coupled to lower link 26 to sense upward or downward force being exerted by operator 54 upon lower link 26. In some implementations, sensor 32 may comprise a fluid pressure sensor, wherein manual forces exerted upon lower link 26 results in a fluid pressure change which is sensed. The signals output by sensors 32 are transmitted to controller 36 which may, based upon such signals, determine a measurement for the manual force MF currently being exerted upon lower link 26 by operator 54.

Controller 36 controls the operation of powered actuator 30 to provide the assist force to the lower link, facilitating easier manual lifting or lowering of lower link 26 by operator 54. Controller 36 comprises memory 60 and processor 62. Memory 60 comprises a non-transitory computer-readable medium which contains instructions for directing operation of processor 62. Processor 62 comprises a processing unit that may perform various functions in accordance with such instructions, such as receiving signals, performing determinations or calculations, and outputting signals. In the example illustrated, instructions contained in memory 60 direct processor 62 to carry out method 100 set forth in FIG. 2.

As indicated by block 104 in FIG. 2, the manual force applied to lower link 26 by operator 54 is sensed. As discussed above, the manual force may be directly sensed, such as with a strain gauge or sensor, or may be indirectly sensed such as by sensing changes in fluid pressures resulting from such an applied manual force, wherein the applying manual force results in the actual force experienced by the lower link 26 or the cylinder-piston assembly supporting lower link 26, differing from the actual force or pressure previously applied by power actuator 30. In such an implementation, the applied manual force may be determined by determining the difference between the current force experienced by the lower link 26 or fluid pressure of the cylinder-piston assembly supporting the lower link 26, and the previously force or fluid pressure applied by the powered actuator 30.

As indicated by block 108, instructions in memory 60 may direct processor 62 to output control signals causing the powered actuator 30 to apply an assist force AF to the lower link 26, wherein the assist force is based upon the sensed/determined manual force. For example, in response to the operator 54 applying an upwardly directed manual force MF, controller 36 may output control signals causing the powered actuator 30 to apply an additional upwards force, based upon the manual force, to assist system the operator in manually lifting lower link 26. In response to the operator 54 applying a downwardly directed manual force MF, controller 36 may output control signals causing the powered actuator 30 to lower the amount of upwardly directed powered force exerted upon the lower link 26 by the powered actuator 30, facilitating the use of gravity to assist system the operator in manually lowering lower link 26. In some circumstances, the control signals output by controller 36 may cause the powered actuator 30 to exert a downward force upon lower link 26.

FIG. 3 is a flow diagram of an example method 200 that may be carried out by hook up assist system 20 to assist an operator in manually raising or lowering a lower link of the three-point hitch system. FIG. 3 illustrates an example of how the assist force may be determined and applied in a continuous closed loop feedback manner. Although described in the context of being carried out by system 20, method 200 may likewise be carried out with other similar vehicles or hook up assist systems.

As illustrated by FIG. 3, method 200 begins at block 201. In some implementations, method 200 may be automatically triggered in response to a startup of the vehicle or tractor having a three-point hitch system 22. In some implementations, method 200 may be triggered in response to an operator input requesting entry into a three-point hitch hook up assist system mode. In some implementations, method 200 may be automatically triggered in response to cameras or other sensors indicating a sufficient degree of proximity of the lower links respect to an implement, such as implement 50.

As indicated by block 204, the force to be applied by powered actuator 30 to lower link 26 is set at an initial value PF1 so as to counter the force of gravity to maintain the lower link 26 in a stationary height or angular position. The value PF1 may be based upon the weight of lower link 26 and the default or current angular position of lower link 26 as well as the location at which powered actuator 30 is connected to the lower link 26.

As indicated by block 208, controller 36 outputs control signals causing powered actuator 30 to apply the powered force PF to the lower link 26. Prior to block 208, the powered force PF being applied is the initial power force PF1 establish in block 204, which supports lowering 26 in a stationary height or angular position.

As indicated by block 212, sensor 32 senses a current upward force CF experienced by the lower link 26. As discussed above, such sensing may be made in a direct fashion a strain gauge or sensor. In some implementations, such sensing may be made in an indirect fashion, such as by sensing fluid pressure differences on the rod and cap side of a piston-cylinder assembly.

As indicated by block 214, in response to the current upward force CF being different than the powered force PF last applied by powered actuator 30, controller 36 makes a determination that the operator is attempting to manually raise or lower link 26. Accordingly, as indicated by block 214, controller 36 adjusts the value for the upward powered force PF based upon the difference between the sensed current force and the previously applied powered force. For example, in some implementations, the powered force may be incremented in a proportional manner relative to the difference between the sensed current force and the applied powered force. In some implementations, the new powered force value is the prior powered force value plus the difference between the current force and the prior powered force (new PF=PF+(CF−PF). As indicated by arrow 218, method 200 returns to block 208, wherein controller 36 outputs control signals causing the powered actuator 30 to apply the new powered force to the lower link 26. Because the new powered force is greater than the previously applied PF, the new powered force assists the operator 54 in lifting or lowering lower link 26.

As indicated by block 220, in response to the current force equaling the immediately prior powered force, controller 36 makes a determination that the operator is no longer attempting to raise or lower the lower link 26. Accordingly, controller 36 outputs control signals to maintain the lower link 26 at the current angular position or height.

in some implementations, controller 36 may take the new angular position of lower link 26 into account when determining what the powered force should be so as to maintain lower link 26 at the current angular position. For example, the new angular position or manual repositioning of the lower link (with the assist system) may alter the amount of force that will maintain the lower link at the current angular position. The initial powered force may be incremented or reduced to take the new angular position of the lower link into account.

In some implementations, the angular position of the lower link may be sensed. In other implementations, the angular position of the lower link 26 may be determined based upon a prior position of the lower link 26 and the previously applied forces to the lower link. As indicated by arrow 222, method 200 returns to block 208, wherein controller 36 outputs control signals causing the powered actuator 30 to continue to apply the same powered force PF to the lower link. As a result, the lower link 26 is supported and retained at the position to which operator 54 manually raised or lowered the lower link 26.

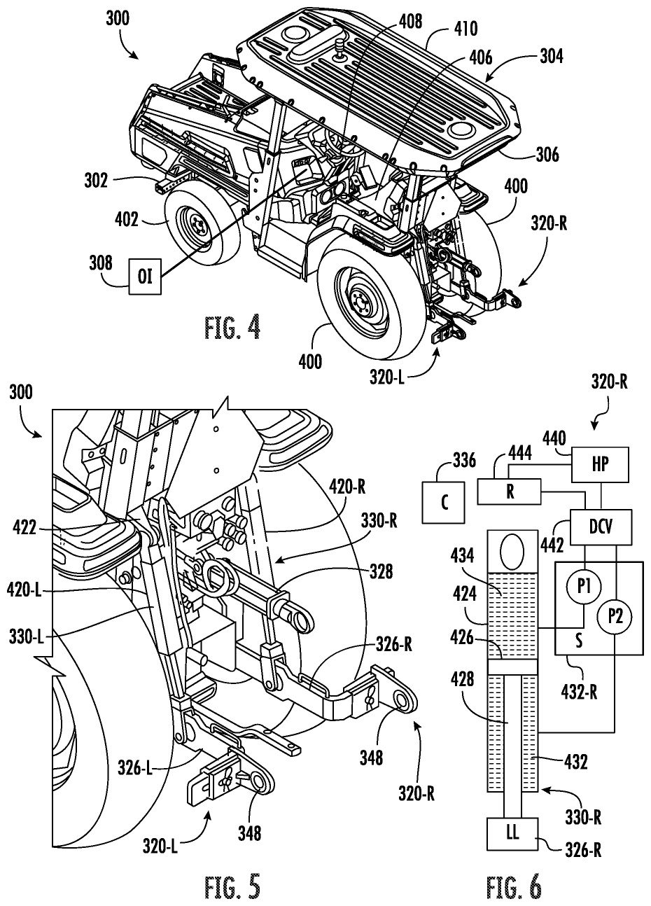

FIGS. 4-6 illustrate portions of an example vehicle in the form of an example tractor 300 incorporating a particular examples of the three-point hitch hookup assist system described in FIGS. 1-3. FIG. 4-6 illustrate an example of how a tractor may control a hydraulic cylinder-piston assembly for each of the lower links of the three-point hitch system to assist the operator in directly manually raising or lowering either of the two lower links. Tractor 300 comprises chassis 302, operator cab 304, sensors 306, operator interface 308, and three-point hitch hookup assist systems 320-L and 320-R.

Chassis 302 comprises the frame for supporting the remaining components of tractor 300. Chassis 302 supports rear wheels 400 and front wheels 402 as well as a power source such as electric battery or an internal combustion engine. Operator cab 304 is supported by chassis 302 and comprises operator seat 406, steering wheel 408 and roof 410.

Roof 410 supports sensor 306. Sensor 306 may comprise a camera or other sensor configured to sense rear regions of tractor 300, including the rearwardly projecting portions of the three-point hitch system 322. Operator interface 308 comprises one or more devices by which an operator may receive information from and provide information or commands to tractor 300. Operator interface 308 may comprise a touchscreen, a display screen and mouse, a lever, a switch, a pushbutton, or the like. In implementations where tractor 300 is autonomous and does not carry an operator, seat 406, steering wheel 408 and roof 410 may be omitted, wherein sensor 306 may be supported at other locations on chassis 302. In such implementations, operator interface 308 may be remote from tractor 300.

FIG. 5 illustrates portions of hookup assist systems 320-L and 320-R in detail. As shown by FIG. 5, hookup assist systems 320-L and 320-R comprise lower links 326-R, 326-L (collectively referred to as lower links 326), upper link 328, and powered actuators 330-R, 330-L (collectively referred to as powered actuators 330). Lower links 326 are each pivotally coupled to chassis 302 to pivot about an axis that is parallel to the rotational axis of rear wheels 400. Each of lower links 326 further comprises an implement connector 348 for alignment with and connection to the corresponding connection point 49 of an implement 50 (schematically shown in FIG. 1).

Powered actuators 330 comprise hydraulic piston-cylinder assemblies 420-R, 420-L that have lower ends coupled to the two lower links 326-R and 326-L, respectively, and upper ends pivotably coupled to chassis 302. In some implementations, piston-cylinder assemblies 420 each have an upper end operatively coupled to a rock shaft 422. In some implementations, piston-cylinder assemblies 420 are coupled to independent actuators to raise and lower assemblies 420 while assemblies 420 are retained at a single length. Powered actuators 330 are powered by a hydraulic pump which supplies pressurized hydraulic fluid to exert forces against an internal piston. The hydraulic pump may be powered by an electric power source such as an electric battery or may be powered by the torque provided by an internal combustion engine.

FIG. 6 illustrates portions of three-point hitch hookup assist system 320-R. As shown by FIG. 6, three-point hitch hookup assist system 320-R comprises lower link 326-R, powered actuator 330-R, sensor 432-R, and controller 336. Powered actuator 330-R comprises piston-cylinder assembly 420-R having a cylinder 424, a piston 426 and a rod 428. Piston 426 partitions the cylinder 424 into a rod side 432 and a piston or cap side 434, each containing a hydraulic fluid 436. Rod 428 extends from piston 426 and is operably coupled to lower link 326-R (schematically illustrated).

As further shown by FIG. 6, powered actuator 330-R additionally comprises hydraulic pump 440, directional control valve 442 and hydraulic reservoir 444. Hydraulic pump 440 delivers a hydraulic fluid under pressure to piston-cylinder assembly 420-R. Hydraulic pump 440 may be powered by an electric battery, an electric mower powered by electric battery, or torque provided by internal combustion engine.

Directional control valve 442, sometimes referred to as a manifold, selectively directs the hydraulic fluid under pressure from pump 440 to one or both of rod side 432 and piston side 434 of assembly 420-R. Directional control valve 442 may return hydraulic fluid from piston-cylinder assembly 420-R to reservoir 444. Hydraulic pump 440 draws hydraulic fluid from reservoir 444.

Powered force sensor 432-R senses the pressures on both sides of piston, P1 on cap side 434 and P2 on rod side 432. In one implementation, powered force sensor 450 comprises fluid pressure sensors (1) situated along the fluid line connecting directional control valve 442, fluidically coupled to piston side 434, or (3) located within or as part of directional control valve 442. Such signals are transmitted to controller 36.

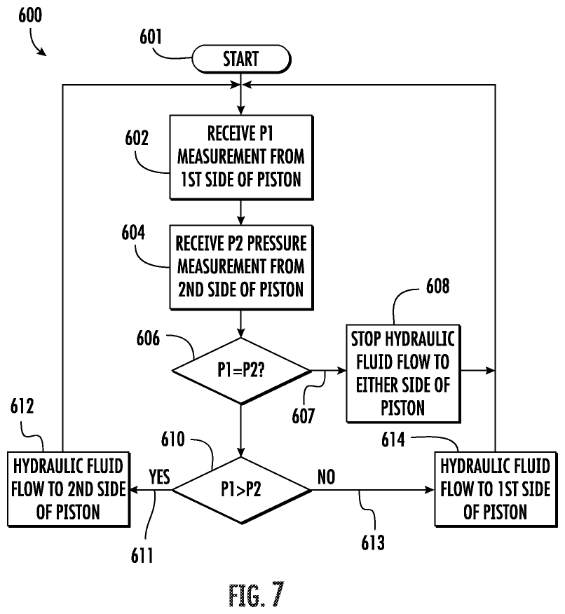

Controller 336 is similar to controller 36 described above in that controller 336 carries out method 100 or method 200 as described above. In the particular example, controller 336 may carry out the closed-loop feedback control method 500 outlined in FIG. 7. As indicated by block 601, the process begins when vehicle 300 enters the hookup assist mode. As discussed above, when tractor 300 is in a hookup assist system mode, controller 36 may provide an assist to the operator by carrying out method 200 described above. In some implementations, tractor 300 enters the hookup assist system mode in response to an input provided by an operator using operator interface 308. In some implementations, tractor 300 enters the hookup assist system mode in response to powering up of tractor 300. In some implementations, tractor 300 enters the hookup assist system mode automatically in response to a determination by controller 36, based upon signals from at least sensor 306, that: (1) tractor 300 is not currently connected to an implement; (2) the rear of tractor 300 or its lower links 326 are within a predefined distance from an implement and/or (3) an operator is present at the rear of tractor 300 or within a predefined distance of either of lower links 326.

At least when in the hookup assist mode, controller 336 receives pressure measurements P1 and P2 from sensor 432-R. As indicated by block 602, controller 336 receives fluid pressure measurement P1 from a first side of piston 426, in the particular example, the cap side 434. As indicated by block 604, controller 336 receives fluid pressure measurement P2 from a second side of piston 426, in the example, the rod side 432.

As indicated by blocks 606 and 608, controller 336 determines the relationship between P1 and P2. Any difference between P1 and P2 reflects an attempt by an operator to manually lift lower link 326R. Based upon the relationship, controller 336 outputs control signals to a hydraulic pump 440 and/or directional control valve 442 to direct flow of hydraulic fluid to either rod side 432 or cap side 434 to assist the operator with the attempt to manually move lower link 326-R.

As indicated by block 606 and arrow 607, when actuator 3030-R is at equilibrium, when P1 equals P2, lower link 326-R is stationary and held at its current position. Controller 336 operates valve 442 such that no additional flow is provided to either side of piston 426. If there was an ongoing flow to either side of piston 426, this hydraulic flow is stopped. Controller 336 returns to block 602 and continues to take measurements of the fluid pressures P1 and P2 and carry out comparisons. As noted above, the frequency at which controller 336 proceeds through block 602, 604 and 606 may occur at a predetermined frequency or at a frequency that is selected by the operator.

As indicated by block 610, arrow 611, and block 612, when fluid pressure P1 is greater than fluid pressure P2, lower link 326-R is experiencing an upwardly directed force. Due to the weight of lower link 326-R, the upwardly directed manual force, by itself, may be insufficient to move the lower link or may render movement of the lower link slow and difficult. However, in response to determining that fluid pressure P1 is greater than fluid pressure P2 (based upon the signals from sensor 432-R), controller 336 outputs control signals to directional control valve 442 to cause additional hydraulic fluid to be supplied to the second side of the piston, the rod side 432, further increasing pressure P2 to assist in lifting piston 426 and raising lower link 326-R. During hydraulic fluid flow to the second side of the piston, controller 336 returns to block 602, 604 and 606 and continues to monitor fluid pressures P1 and P2. The supply of additional hydraulic fluid to the second side of the piston 426, rod side 432, continues until equilibrium is attained, wherein P2 and P1 are once again equal. Once equilibrium is attained, hydraulic flow to the second side of piston 426, the rod side 432, is stopped per block 608.

If the fluid pressure P1 is not greater than fluid pressure P2 per block 610 and is not equal to P2 per block 606, fluid pressure P2 is greater than fluid pressure P1. When fluid pressure P2 is greater than fluid pressure P2, lower link 326-R is experiencing a downwardly directed force. Due to the weight of lower link 326-R, the downwardly directed manual force, by itself, may be insufficient to move the lower link or may render movement of the lower link slow and difficult. However, in response to determining that fluid pressure P2 is greater than fluid pressure P1 (based upon the signals from sensor 432-R), controller 336 outputs control signals to directional control valve 442 to cause additional hydraulic fluid to be supplied to the first side of the piston, the cap side 434, further increasing pressure P1 to assist in lowering piston 426 and lowering lower link 326-R. During hydraulic fluid flow to the first side of the piston, controller 336 returns to block 602, 604 and 606 and continues to monitor fluid pressures P1 and P2. The supplying of additional hydraulic fluid to the first side of the piston 426, cap side 434, continues until equilibrium is attained, wherein P2 and P1 are once again equal. Once equilibrium is attained, hydraulic flow to the first side of piston 426, the cap side 434, is stopped per block 608.

In the example illustrated, three-point hitch hookup assist system 320-L is similar to three-point hitch hookup assist system 320-R. As result, the lower links 326 may be raised or lowered independent of one another, wherein each of links 326 may be manually raised or lowered with a provided assist force. In some implementations, both of the three-point hitch hookup assist system 320 may share a common controller 36 which controls both of systems 320. In some implementations, both of system 320 may share a common hydraulic pump 440, a common directional control valve 442 and/or a common reservoir 444.

In some implementations, lower links 326 may be physically coupled to one another so as to pivot in unison. In such an implementation, one of the systems 320 may be omitted. In such an implementation, the manual application of force to one of the lower links 326 will result in the generation of an assist system force, whereby an operator may manually raise or lower both of lower links 326 in unison.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A vehicle comprising:
a three-point hitch hookup assist system comprising:
a lower link having a first connection about which the lower link pivots and an implement connector;
a powered actuator to pivot the lower link;
a first sensor coupled to the lower link or the powered actuator to output signals indicating a manual force applied by an operator to the lower link; and
a controller to output control signals to the powered actuator to cause the powered actuator to apply an assist force to the lower link based upon the manual force.

2. The vehicle of claim 1 further comprising a second three-point hitch hook up assist system comprising:
a second lower link having a second connection about which the second link pivots and a second implement connector;
a second powered actuator to pivot a second lower link;
a second sensor coupled to the second lower link to sense a second manual force applied by an operator to the second lower link,
wherein the controller is configured to output control signals to the second powered actuator to cause the second powered actuator to apply a second assist system force to the second lower link based upon the second manual force.

3. The vehicle of claim 1, wherein the powered actuator comprises a hydraulic piston-cylinder assembly and wherein the sensor comprises a first fluid pressure sensor to sense fluid pressure on a rod side of the hydraulic piston-cylinder assembly and a second fluid pressure sensor to sense fluid pressure on a cap side of the hydraulic piston-cylinder assembly.

4. The vehicle of claim 1, wherein the assist force is based upon a weight of the lower link.

5. The vehicle of claim 1, wherein the assist force has a value to bring a resultant weight of the lower link felt by the operator, when pivoting the lower link, to null.

6. The vehicle of claim 1 further comprising a position sensor to sense an angular position of the lower link, wherein the control signals are based on the angular position of the lower link.

7. The vehicle of claim 1, wherein the controller outputs the control signals in a closed-loop feedback comprising:
applying a powered force to the lower link;
sensing a current upward force experienced by the lower link; and
applying the assist force to the lower link, the assist force comprising the powered force plus a difference between the powered force and the current upward force.

8. The vehicle of claim 1, wherein the controller is configured to apply the assist force at an operator selected frequency.

9. The vehicle of claim 1 further comprising a sensor to output operator presence signals indicating presence of an operator proximate to the lower link, wherein the controller is configured to apply the assist force in response to the vehicle being in a hookup assist mode and wherein the controller is configured to enter the hookup assist mode based upon operator presence signals.

10. A method for assisting an operator with manual positioning of a lower link of a three-point hitch, the method comprising:
sensing manual force applied to a lower link of a three-hitch; and
applying an assist force to the lower link based upon the sensed manual force.

11. The method of claim 10 further comprising:
sensing a second manual force applied to a second lower link of a three-hitch system; and
applying a second assist force to the second lower link based upon the second manual force.

12. The method of claim 10, wherein the sensing of the manual force applied to the lower link comprises sensing a hydraulic pressure change in a piston-cylinder assembly.

13. The method of claim 10, wherein the assist force is based upon a weight of the lower link.

14. The method of claim 10, wherein the assist force has a value to cause a resultant weight felt by the operator, during pivoting of the lower link, to be null.

15. The method of claim 10 further comprising sensing an angular position of the lower link, wherein the assist force is based on the angular position of the lower link.

16. The method of claim 10 further comprising executing a closed-loop feedback, the closed-loop feedback comprising:
applying a powered force to the lower link;
sensing a current upward force experienced by the lower link; and
applying the assist force to the lower link, the assist force comprising the powered force plus a difference between the powered force and the current force.

17. The method of claim 10, wherein application of the assist force is at an operator selected frequency.

18. A tractor comprising:
a chassis;
a three-point hitch hookup assist system comprising:
a first lower link pivotably coupled to the chassis and having a first implement connector;
a second lower link pivotably coupled to the chassis and having a second implement connector;
an upper link pivotably coupled to the chassis and having a third implement connector;
a powered actuator to pivot the first lower link;
a sensor coupled to the first lower link to sense a manual force applied by an operator to the first lower link; and
a controller to output control signals to the first actuator to cause the first powered actuator to apply an assist system force to the first lower link based upon the sensed manual force.

19. The tractor of claim 18 further comprising a second three-point hitch hookup assist system comprising:
a second powered actuator to pivot the second lower link independent of pivoting of the first lower link;
a second sensor coupled to the second lower link to sense a second manual force applied by an operator to the second lower link,
wherein the controller is configured to output control signals to the second powered actuator to cause the second powered actuator to apply a second assist system force to the second lower link based upon the second manual force.

20. The tractor of claim 18, further comprising a directional control valve, wherein the powered actuator comprises a hydraulic cylinder-piston assembly comprising a piston, wherein the sensor is configured to sense a first fluid pressure on a first side of the piston and a second fluid pressure on a second side of the piston, and wherein the controller is configured to:
output control signals directing the directional control valve to supply additional hydraulic fluid to the second side of the piston in response to the first fluid pressure being greater than the second fluid pressure;
output control signals directing the directional control valve to supply additional hydraulic fluid to the first side of the piston in response to the second fluid pressure being greater than the first fluid pressure; and
discontinue supply of hydraulic fluid to either the first side of the piston or the second side of the piston in response to the first fluid pressure equaling the second fluid pressure.
